(19) United States
(12) Patent Application Publication
(10) Pub. No.: US 2014/0048627 A1
(43) Pub. Date: Feb. 20, 2014

(54) EASY-TO-CLEAN SPRAY GUN, ACCESSORIES THEREFOR, AND MOUNTING AND DISMOUNTING METHODS

(71) Applicants: Ewald Schmon, Granfenberg (DE); Peter Dettlaff, Remseck (DE); Jens Brose, Ottmarsheim (DE)

(72) Inventors: Ewald Schmon, Granfenberg (DE); Peter Dettlaff, Remseck (DE); Jens Brose, Ottmarsheim (DE)

(73) Assignee: SATA GMBH & CO., Kornwestheim (DE)

(21) Appl. No.: 14/113,649

(22) PCT Filed: May 5, 2012
(86) PCT No.: PCT/EP2012/001939

§ 371 Date: Oct. 24, 2013

(30) Foreign Application Priority Data
Jun. 30, 2011 (DE) 10 2011 106 060.3

(51) Int. Cl. B05B 9/01

(52) U.S. Cl. CPC B05B 9/01
USPC 239/526; 29/890.09

(57) ABSTRACT

A spray gun includes a one-piece main body, a trigger, a paint needle operating element coupled to the trigger, a paint needle coupled to the paint needle operating element, and an exchangeable spray agent guiding unit, the inlet region of which is or can be connected to a material supply device for the material to be sprayed, wherein the main body has at least one opening for receiving the exchangeable spray agent directing unit. Also disclosed is a material supply device, a cover, a method for mounting an exchangeable spray agent guiding unit in or on a spray gun having a one-piece main body, and a method for removing an exchangeable spray agent directing unit from or out of a one-piece spray gun.

### FIELD OF THE INVENTION

The invention pertains to an easy-to-clean spray gun, accessories therefor, as well as a mounting and a dismounting method.

### BACKGROUND

Conventional spray guns essentially consist of a base body that features a handle and a head section and contains compressed air conduits, a nozzle set, a compressed air connection, a trigger, an air guidance system with an air valve, an air nozzle and a mechanism for adjusting the volume and the pressure of the air flowing through the compressed air conduits, as well as a material guidance system with a paint needle and a mechanism for adjusting the material volume. The spray gun head features a material-conveying region, through which the material to be sprayed flows from a spray medium inlet to a spray medium outlet that is typically realized in the form of a material nozzle. A material supply, for example, in the form of a reservoir or a supply line from an external material storage system is provided at the spray medium inlet. Conventional reservoirs consist, for example, of gravity-feed cups, suction-feed cups or laterally mounted cups. The pressure difference can be produced by means of a material conveying device or by means of air flowing past an opening on the material supply. All free-flowing materials such as, for example, paints, varnishes, adhesives or the like may be considered as spray mediums.

The compressed air required for the spraying process is supplied at the air connection that is arranged on or in the pistol grip. The air valve is opened by actuating the trigger up to a first pressure point. When the trigger is additionally pulled back, the paint needle is retracted from the spray nozzle. The spray medium then respectively flows out of the material nozzle due to the gravitational force or a pressure difference and is atomized by the compressed air exiting the air nozzle.

Spray guns of this type have proven themselves in practical applications for many decades. However, it is disadvantageous that they respectively require careful cleaning of the material-conveying regions after each use and before each material change because clogging of said regions, as well as a contamination of the spray medium, could otherwise occur. In the prior art, this problem is solved by utilizing a material guide in the form of a cartridge, i.e., in the form of an exchangeable insert or exchangeable spray medium guide unit, that preferably consists of a disposable article. For example, DE 3016419 C2 discloses an advantageous spray gun of this type with a holding region and with a head that is equipped with a cartridge, wherein the cartridge features an inlet region for a material-conveying conduit that ends in an outlet region, wherein the inlet region of the cartridge is connected or can be connected to a reservoir for the material to be sprayed, and wherein the cartridge preferably guides at least one material-conveying component of the spray gun. This spray gun has a head that is divided into two parts, and features a rear region with respect to the spraying direction and a front region with respect to [as] the spraying direction. The rear end of the front region of the two-part head is equipped with a plug-type fitting for a cartridge with a tubular material-conveying conduit that extends in the direction of the spray jet, and in the interior of which a nozzle needle or paint needle is respectively arranged. The nozzle needle can be moved back and forward in the direction of the spray jet by means of a lever and spring mechanism such that the material to be sprayed can pass the nozzle arranged in the outlet region. The cartridge is held in the head by means of pin connections. After its use, the pin connections can be disengaged and the two head regions can be pivoted apart from one another such that the cartridge including the paint needle can be removed from the head and then discarded. A new cartridge can then be respectively fixed on or in the spray gun. In this way, cleaning of the material-conveying regions of the spray gun is not required. However, the pin connections are relatively complicated, as well as difficult to manufacture and disengage, and also do not always ensure a flawless operational reliability.

Another spray gun with an exchangeable cartridge is described in DE 10 2004 027 789 A1. The object of this publication is a two-part spray gun, in which each of the two parts features a recess for accommodating an exchangeable paint medium guide unit. The exchangeable paint medium guide unit is inserted into the receptacle of the first gun part. The second gun part is subsequently attached to the first part and fixed with a screw. Due to these numerous preparatory steps, the set-up of the spray gun is very elaborate and time-consuming. The two-part design of the gun furthermore requires immense additional effort during the manufacture because the two gun parts are not identical such that two production lines are required. This increases the manufacturing costs of the spray gun. In addition, it is also difficult to seal the gun cavities relative to the outside air.

Another embodiment of a spray gun with an exchangeable cartridge is disclosed in WO 2009/015260 A2. In this case, the gun essentially also consists of two parts, namely a front and a rear part that are connected to one another by means of a hinge. In order to insert the cartridge, the front part is pivoted downward such that the cartridge receptacle is exposed. After inserting the cartridge, the front part is once again pivoted upward and connected to the rear part by means of a spring-loaded latch. Although this allows a faster insertion of the cartridge into the gun than in the above-described prior art, the quality of the hinge, particularly its accuracy and its stability, is subject to very strict requirements. The manufacturing effort is therefore very high in comparison with a conventional spray gun and the production is associated with substantial additional costs.

### SUMMARY

It is therefore an objective of the present invention to develop a spray gun of the initially cited type that can be manufactured more cost-efficiently and functions reliably at all times, wherein particularly a cartridge or another type of exchangeable insert can be mounted on or in and once again removed from or out of said spray gun in a less complicated yet reliable fashion.

It is another objective of the invention to make available an exchangeable spray medium guide unit that is suitable for use in connection with an inventive spray gun with one-piece base body.

It is another objective of the present invention to develop a material supply device that is suitable for use in connection with an inventive spray gun with one-piece base body and an inventive exchangeable spray medium guide unit.

It is a fourth objective of the present invention to make available a cover that is suitable for use in connection with an inventive one-piece spray gun and an inventive exchangeable spray medium guide unit.

It is another objective of the present invention to make available a method, by means of which the exchangeable spray medium guide unit can be arranged in or on an inventive spray gun with one-piece base body.

It is yet another objective of the present invention to make available a method, by means of which the exchangeable spray medium guide unit can be removed from or out of an inventive spray gun with one-piece base body.

The first objective is attained with a spray gun with one-piece base body according to Claim 1 that, among other things, features a base body, a trigger, a paint needle-actuating element that is coupled to the trigger, a paint needle that is coupled to the paint needle-actuating element and an exchangeable spray medium guide unit, the inlet region of which is connected or can be connected to a material supply device for the material to be sprayed, wherein the base body features a recess for accommodating the exchangeable spray medium guide unit. In comparison with conventional multipiece spray guns according to the prior art, the spray gun with one-piece base body is characterized in that the base body of the gun consists of only one piece. No parts of the base body need to be moved such as, for example, pivoted, screwed on or unscrewed, clipped or bonded in order to insert or remove the exchangeable spray medium guide unit. Attachments remain unaffected by this one-piece design, i.e., the spray gun with one-piece base body may feature several attachments such as, e.g., a trigger, a circular/broad jet control, a locking screw, an air micrometer, a material volume control or the like.

The second objective is attained with an exchangeable spray medium guide unit that can be arranged in or on the one-piece spray gun. The exchangeable spray medium guide unit is designed for being arranged in or on the one-piece spray gun . . . .

The third objective is attained with a material supply device that can be arranged on the exchangeable spray medium guide unit or on the spray gun with one-piece base body or on both. The material supply device may consist of a gravity-feed cup, a suction-feed cup or a laterally mounted cup or of a supply line that is connected or can be connected to an external material storage system such as, e.g., a paint, varnish or adhesive container. In this way, the spray medium can respectively flow or be sucked into the exchangeable spray medium guide unit and into the spray gun with one-piece base body directly from the material supply device.

The fourth objective is attained with a cover that can be arranged on the exchangeable spray medium guide unit or on the spray gun with one-piece base body or on both. The cover may consist, for example, of an air distribution ring or a nozzle set that, for example, can be screwed on the base body by means of an air nozzle ring or arranged thereon otherwise.

The fifth objective is attained with a method in which the exchangeable spray medium guide unit is arranged in or on a recess of the base body of the spray gun with one-piece base body.

The sixth objective is attained with a method in which the exchangeable spray medium guide unit is removed from or out of a recess of a base body of the spray gun with one-piece base body.

Advantageous embodiments form the objects of the dependent claims.

The spray gun with one-piece base body may be designed for use in connection with any fluid or any aerosol such as, for example, for the application of paints, varnishes or adhesives onto objects.

The inventive spray gun with one-piece base body features a recess that is realized in such a way that it can accommodate an exchangeable spray medium guide unit. In the operating mode, a spray medium is supplied to the exchangeable spray medium guide unit through an inlet region. The spray medium flows through the exchangeable spray medium guide unit and then to a paint outlet, at which it exits the spray gun in an atomized fashion downstream of the nozzle under the influence of compressed air or is atomized near the spray gun. The atomization may also be realized with at least one electric field, ultrasound, high rotation or another method or with combinations of several different methods. The inlet region of the exchangeable spray medium guide unit may be connected or connectable to a material supply device. This material supply device may consist, for example, of a gravity-feed cup, a suction-feed cup or a laterally mounted cup or of a supply line that is connected or can be connected to an external material storage unit such as, e.g., a paint, varnish or adhesive container. It would also be conceivable to utilize a combination of these material supply devices. In addition, the material supply device may not only be connected to the inlet region of the exchangeable spray medium guide unit, but also to an inlet region of the base body that may be formed by the recess. In this case, the spray medium can flow into the inlet region of the exchangeable spray medium guide unit via this inlet region of the base body.

The exchangeable spray medium guide unit may be realized in the form of a disposable part that is thrown away after its use. When the spray gun needs to be used again, a new exchangeable spray medium guide unit is inserted into the recess of the spray gun. However, it would also be conceivable to remove the exchangeable spray medium guide unit from the gun after its use for cleaning purposes and to subsequently reinsert the exchangeable spray medium guide unit.

The recess is preferably arranged on the upper side of the base body, laterally on the base body or on the underside of the base body. The recess may extend over several sides, it may be arranged on several sides or it may extend from one side to at least one other side. In this way, the spray gun can be predestined for different types of material supply devices. A recess should be provided on the upper side of the base body, in particular, if the spray gun is intended for use in connection with a gravity-feed cup. A lateral recess allows the use of a laterally mounted cup and a recess on the underside of the base body is advantageous when a suction-feed cup is used. An external material supply device in the sense of a so-called tank gun can be arranged on any type of recess. If one or more recesses are provided on different sides, it is possible to align the inlet region of the exchangeable spray medium guide unit in different positions and to thusly utilize different material supply devices with the same spray gun.

The recess preferably extends from a spray medium inlet to a spray medium outlet of the base body. In this way, it is possible to convey the spray medium from a material supply device to the nozzle of the spray gun.

In a particularly preferred embodiment, the recess features at least one concave region. In this way, it is suitable for accommodating a cylindrical, conical or tapered exchangeable spray medium guide unit.

The at least one concave region is preferably open on its side that faces the spray medium outlet, [or] on its side that faces away from the spray medium outlet, toward the bottom or toward the top. It would also be conceivable to provide several open sides or oblique openings.

It is preferred that the at least one concave region at least partially has an aperture angle of less than 180°, particularly an aperture angle between 100° and 179°. In this way, the exchangeable spray medium guide unit is inserted into the recess while being subjected to a slight elastic deformation and positively held therein without applying an external force. It can be removed from the recess once again while being subjected to a slight elastic deformation if an external force is applied by a user.

The recess may be realized in such a way that the spray medium guide unit cannot be inserted into or arranged on and removed from the base body with a purely linear motion, but the insertion and removal motion rather needs to include at least one rotatory component such as, for example, a pivoting motion. This provides the advantage that the exchangeable spray medium guide unit is positively held by the base body without additional fixing means.

The recess is preferably realized in such a way that it is possible to pivot or slide the exchangeable spray medium guide unit into the recess or to arrange the exchangeable spray medium guide unit in or on the recess by means of several superimposed or successive motions.

The insertion of an exchangeable spray medium guide unit into a recess that may be situated on the upper side or on the underside of the base body or laterally thereon may take place, for example, as follows: the exchangeable spray medium guide unit is essentially moved into the vicinity of the recess coaxial to the axis of the recess (spray medium inlet axis) or parallel thereto such that the spray medium outlet of the exchangeable spray medium guide unit points forward. Once the spray medium outlet of the exchangeable spray medium guide unit is positioned approximately flush with the spray medium outlet of the base body, a pivoting motion is carried out in order to coaxially align the spray medium outlet of the exchangeable spray medium guide unit with the spray medium outlet of the base body. Subsequently, the exchangeable spray medium guide unit can be coaxially displaced or inserted in the direction of the spray medium outlet of the base body. These steps are carried out in the reverse sequence and in the opposite direction in order to remove the exchangeable spray medium guide unit.

In another embodiment of the inventive spray gun with one-piece base body, in which the recess is essentially situated laterally on the base body and extends up to its upper side and/or its underside, the insertion of the exchangeable spray medium guide unit takes place as described below: the exchangeable spray medium guide unit is pivoted in the direction of the spray medium outlet of the base body such that its spray medium outlet points forward. In this case, the spray medium inlet of the exchangeable spray medium guide unit may be inclined relative to its intended alignment. Subsequently, the inserting process may comprise a displacement or insertion of the exchangeable spray medium guide unit in the direction of the spray medium outlet of the base body, for example, until the exchangeable spray medium guide unit at least regionally abuts on a contact region of the base body or of an attachment. The inserting process may furthermore comprise a slewing motion of the exchangeable spray medium guide unit, particularly its spray medium inlet, into the intended position. When a gravity-feed cup is used, this spray medium inlet essentially points upward or obliquely upward and in one other direction. When a suction-feed cup or an external material supply device is used, the spray medium inlet of the exchangeable spray medium guide unit essentially points downward or obliquely downward and in one other direction. When using a laterally mounted cup, the exchangeable spray medium guide unit can be pivoted into position from above or below and then subjected to a slewing motion in the lateral direction. In any case, it is also possible to realize the recess in such a way that the exchangeable spray medium guide unit can be pivoted into position from another side or from any side and subsequently subjected to a slewing motion into the intended position.

The material supply device can be arranged on the exchangeable spray medium guide unit either before or after the exchangeable spray medium guide unit is inserted into the recess of the base body. In the first instance, the material supply device and the exchangeable spray medium guide unit are jointly arranged in or on the recess in the form of an assembly.

The placement of the paint needle may likewise take place before or after the exchangeable spray medium guide unit is inserted. It would be conceivable to place the paint needle into the exchangeable spray medium guide unit before it is arranged in or on the recess. Subsequently, the paint needle is separably or inseparably connected to the paint needle-actuating element by means of a coupling element. The paint needle-actuating element may either be permanently arranged in the spray gun or placed therein before or after the paint needle is inserted. It would likewise be conceivable that the paint needle is only placed into the exchangeable spray medium guide unit after the attachment thereof. This may take place in conjunction with the paint needle-actuating element if the paint needle and the paint needle-actuating element are already assembled prior to the insertion. Alternatively, the paint needle may be initially inserted into the exchangeable spray medium guide unit before the paint needle-actuating element is connected to the paint needle.

The paint needle may be arranged in the exchangeable spray medium guide unit, for example due to friction, such that it presses against and thusly closes the outlet opening of the exchangeable spray medium guide unit after the exchangeable spray medium guide unit has been removed from the recess. In this way, the exchangeable spray medium guide unit can serve as a cup cover. Other covering means can therefore be eliminated.

In addition, the process of inserting and of removing the exchangeable spray medium guide unit may in any case comprise an actuation of the trigger, for example, in order to move the paint needle-actuating element out of the path of the exchangeable spray medium guide unit.

The exchangeable spray medium guide unit is preferably held in the recess by means of a positive fit, a taper or a restraint. In this way, a first immobilization can be realized without additional means.

At least one contact region in or on the recess preferably ensures a radial and/or axial immobilization of the exchangeable spray medium guide unit in the recess. The contact region may feature, for example, a shoulder, a ring, a cone, a web, a hook and/or an eyelet that may be arranged on the exchangeable spray medium guide unit and/or on the base body. It would furthermore be possible to arrange a contact element on the exchangeable spray medium guide unit and a corresponding counter element on the base body. The contact region may also be realized integrally with the base body and comprise a sealing element or itself act as a seal and as a guide.

The base body preferably features one or more compressed air conduits that preferably extend in at least one part of the base body that does not contain a recess. In this way, compressed air can be conveyed from a compressed air connection to an air nozzle regardless of the size, shape or position of the recess.

In a particularly preferred exemplary embodiment, the exchangeable spray medium guide unit can be locked on or in the base body by means of at least one fixing element. In addition to a first immobilization, this ensures a secure retention of the exchangeable spray medium guide unit. The fixing means may feature, for example, a mechanical, magnetic, pneumatic or hydraulic element. It may comprise a nonpositive or positive connection, an integral hinge, a catch mechanism, an eccentric element or a screw mechanism.

It would furthermore be possible to fix the exchangeable spray medium guide unit in or on the base body by means of the material supply device. This may be realized, e.g., in the form of a restraint, i.e., the diameter of the spray medium inlet of the exchangeable spray medium guide unit is enlarged when the material supply device is attached, for example when respectively screwing in or on or inserting or attaching a cup, such that the outer wall of the spray medium inlet of the exchangeable spray medium guide unit is pressed against a region of the spray medium inlet of the base body.

In addition, the immobilization in or on the base body may be realized by means of a cover that is arranged or can be arranged on the base body. For this purpose, it would be possible, for example, to utilize an air distribution ring or a nozzle set that, for example, can be screwed on the base body by means of an air nozzle ring or arranged thereon otherwise. This component or these components may also be realized in the form of disposable articles that are intended for single use and manufactured of metal and/or plastic.

Magnetic elements may consist, for example, of magnets or magnetic adhesive tapes that are arranged or can be arranged on the exchangeable spray medium guide unit and/or on the base body. It would also be conceivable that the exchangeable spray medium guide unit and/or the base body themselves are realized magnetically or magnetizable or at least feature corresponding regions.

It would be conceivable that at least one pneumatic and/or hydraulic element such as, for example, a cylinder, a pneumatic muscle or an air cushion or oil cushion is arranged or can be arranged on the exchangeable spray medium guide unit and/or on the base body and locks the exchangeable spray medium guide unit on the base body upon its activation.

The at least one pneumatic element may be connected or connectable to a separate compressed air supply. This separate compressed air supply may be realized, for example, in the form of a compressor that is connected to the pneumatic element by means of an air conveying unit. A junction of the supply line may also be provided in the region of the compressed air supply or compressed air distribution or on a compressed air generator such as a compressor, wherein one supply line supplies the compressed air conduits with air and the other supply line supplies the pneumatic element with air. The individual supplies may feature common or separate means for adjusting the air volume and/or the air pressure.

The at least one pneumatic element may alternatively or additionally be connected to the same compressed air supply as the compressed air conduits in the base body. This means that compressed air flows from a compressed air connection of the spray gun into the compressed air conduits in the base body, as well as into the pneumatic element. The advantage of this embodiment can be seen in that the pneumatic element can be activated with only one compressed air connection in order to lock the exchangeable spray medium guide unit. The pneumatic element may be realized such that it can already be activated by connecting an air supply to the compressed air connection of the spray gun. The activation may furthermore be realized by actuating the trigger or by means of a separate activation mechanism.

The exchangeable spray medium guide unit and the at least one fixing means may either be realized integrally or such that the exchangeable spray medium guide unit is connected or can be connected to the at least one fixing means in a separable or inseparable fashion. The fixing means may be manufactured together with the exchangeable spray medium guide unit such as, for example, injection-molded, bonded, welded, soldered or clipped thereon, inserted therein or attached thereto, fused thereon or connected or connectable thereto otherwise.

In a particularly preferred embodiment, at least part of the paint needle extends through the exchangeable spray medium guide unit. It would be conceivable that at least one sealing means is arranged or can be arranged between the paint needle and the exchangeable spray medium guide unit in order to prevent an undesirable escape of spray medium. This at least one sealing means may be connected to the exchangeable spray medium guide unit or to the paint needle or to both. In the latter instance, the sealing means needs to be so large that a relative motion between the exchangeable spray medium guide unit and the paint needle is possible. The at least one sealing means may consist, for example, of a sealing lip that is injection-molded on the respective element, a film seal, a push-through membrane, a corrugated membrane, a bellows membrane, a ring seal or another sealing means.

The paint needle may consist of one piece or several pieces and be manufactured of a metal or a metal alloy and/or of a plastic, a plastic mixture, a plastic alloy and/or a reinforced plastic or a plastic compound. The plastic may be reinforced, for example, with glass fibers or carbon fibers, with other fibers or with particles such as nanoparticles, particularly carbon nanotubes. It would be conceivable that different regions of the paint needle consist of different materials.

The paint needle-actuating element may be separably coupled to the paint needle or permanently connected to the paint needle. The coupling may be realized, for example, by means of a gearing, a bolt coupling, a ball coupling or a prism coupling. It would also be conceivable to use combinations of different couplings.

The paint needle-actuating element and the paint needle preferably are or can be coupled or are or can be connected to one another in a rotationally rigid fashion. A rotation of the components could complicate the removal thereof or unintentionally disengage the coupling.

The exchangeable spray medium guide unit may consist of one component or several components and be manufactured of different materials. For example, the exchangeable spray medium guide unit may be composed or manufactured of different metals and/or plastics. Different regions of the one-piece exchangeable spray medium guide unit, as well as of the multipiece exchangeable spray medium guide unit, may be colored differently. For example, the region, through which the paint needle extends, may have a certain color or be transparent while the spray medium inlet region has a different color. The colors may already be applied or incorporated or produced by means of in-mold labeling during the manufacturing process, as well as thereafter. In a preferred embodiment, different materials are at least partially colored differently. For example, one plastic may have a different color than another plastic, one metal may have a different color than another metal or a metal may have a different color than a plastic.

The advantages of the one-component design can be seen, among other things, in a simple and cost-efficient manufacture and in that no assembly is required.

The exchangeable spray medium guide unit may consist of at least two components that are connected or can be connected to one another in a separable or inseparable fashion. One component may consist of a functional component that has a function other than or in addition to guiding the spray medium. Such a function may consist, for example, of locking the exchangeable spray medium guide unit in the base body or fixing a material supply device on the exchangeable spray medium guide unit. It would also be conceivable that one component is realized in the form of a disposable article and another component is intended for multiple uses. One component may consist of a harder and/or stronger material than the other component. Particularly the needle-guiding region may be at least partially or regionally harder or stronger than the spray medium inlet region or vice versa. In this way, tribological requirements and tolerance requirements or requirements with respect to the manufacturing technology can be fulfilled in a superior or simpler fashion.

The exchangeable spray medium guide unit may feature at least one nozzle that can be separably or inseparably attached. The nozzle is of decisive importance for the quality of the spray gun and of the spraying results achieved with the spray gun. This is the reason why it must fulfill the strictest requirements with respect to manufacturing tolerance and dimensional stability. It may therefore be advantageous to manufacture the nozzle separately and to subsequently attach the nozzle to another, less critical part of the exchangeable spray medium guide unit. Exchangeable nozzles furthermore make it possible to use different nozzle sizes. The nozzle preferably consists of a harder and/or stronger material than the first component of the exchangeable spray medium guide unit. In this way, it has a greater dimensional stability and is less sensitive to the application of a force. In this case, one component may also be realized in the form of a disposable article and another component may be intended for multiple uses. It would also be conceivable that the one-component exchangeable spray medium guide unit is provided or can be provided with a separate nozzle.

One component of the exchangeable spray medium guide unit may consist of an elastic material or of a material that can be deformed otherwise in order to simplify its insertion into the base body. It would be conceivable to realize at least one component of the exchangeable spray medium guide unit in an inflatable fashion. It may therefore be arranged in or on the recess, for example, before it is connected to an air supply. This air supply may consist of a separate air supply, but it would also be conceivable to inflate the inflatable, exchangeable spray medium guide unit with the air supply that also supplies the spray gun with air. It would also be conceivable to utilize a combination of the two supplies such as, for example, a separate preliminary supply that is maintained until the exchangeable spray medium guide unit can be inflated with the air flowing through the spray gun.

The exchangeable spray medium guide unit may at least consist of a first component that can be placed into the base body or arranged thereon in the region of the spray medium outlet and a second component that can be placed into the base body or arranged thereon in the region of the spray medium inlet. It is therefore possible, for example, to place one component into the base body from the front through the spray medium outlet and another component from above through the spray medium inlet. The two components may join and overlap in a certain region and be connected to one another. In this way, a form-fitting retention of the assembled exchangeable spray medium guide unit in the base body is ensured.

In an exchangeable spray medium guide unit that consists of several components, it would be conceivable that at least one sealing means is arranged or can be arranged in the connecting region of the components in order to prevent an undesirable escape of spray medium.

In a preferred embodiment of the spray gun with one-piece base body, the exchangeable spray medium guide unit features at least one element for being connected to a material supply device. In this way, the material supply device can be directly attached to the exchangeable spray medium guide unit. The connection to the base body can be eliminated. The element may feature at least one catch mechanism, at least one connecting rail, at least one thread or at least one thread segment. It would alternatively or additionally also be conceivable that the exchangeable spray medium guide unit can be bonded, soldered, welded or attached to the material supply device or inserted therein.

The exchangeable spray medium guide unit may be connected to and locked on the material supply device. However, it may also be fixed on the base body and only indirectly connected to the material supply device.

At least one sealing means such as, for example, a ring seal may be arranged between the exchangeable spray medium guide unit and the material supply device. However, the seal may also be produced by the material supply device and/or the exchangeable spray medium guide unit, for example, if at least one of the two devices is manufactured of a softer material or the two devices are connected to one another, for example, by means of the thread.

The exchangeable spray medium guide unit and the material supply device may be realized integrally. This is particularly advantageous if the exchangeable spray medium guide unit and the material supply device such as, for example, a cup are realized in the form of disposable articles intended for single use.

If the exchangeable spray medium guide unit consists of several components, it would be conceivable that one component of the exchangeable spray medium guide unit is connected or can be connected to the material supply device in a separable or inseparable fashion. The other component of the exchangeable spray medium guide unit may in turn be connected or connectable to this connection.

The exchangeable spray medium guide unit may be manufactured of a metal or a metal alloy and/or of a plastic, a plastic mixture, a plastic alloy and/or a reinforced plastic or a plastic compound. The plastic may also be reinforced in this case, for example, with glass fibers or carbon fibers, with other fibers or with spherical or differently shaped particles such as nanoparticles, particularly carbon nanotubes. Other reinforcements or stabilizing options may also be considered.

The exchangeable spray medium guide unit preferably extends beyond the recess in the region of the spray medium outlet of the base body. In this way, contact between the spray medium and the recess can be avoided such that no cleaning of the recess is required.

The exchangeable spray medium guide unit may alternatively end before the recess or flush therewith in the region of the spray medium outlet of the base body.

The exchangeable spray medium guide unit may also extend beyond the recess in the region of the spray medium inlet of the base body. In this way, the connection of the exchangeable spray medium guide unit to a material supply device can be simplified.

However, the exchangeable spray medium guide unit may also end before the recess or flush therewith in the region of the spray medium inlet of the base body. Consequently, only part of the recess needs to be cleaned after the contact with a spray medium.

The recess may be designed for accommodating exchangeable spray medium guide units of different sizes.

In a particularly preferred embodiment of the spray gun with one-piece base body, at least one sealing means is arranged or can be arranged between the exchangeable spray medium guide unit and the base body. In this way, an undesirable material flow and/or air flow can be prevented and a firm seat of the exchangeable spray medium guide unit in the recess can be ensured. The at least one sealing means may be permanently or separably arranged on the exchangeable spray medium guide unit or on the base body. In both instances, the at least one sealing means may be injection-molded or bonded on the respective component. It would alternatively or additionally also be conceivable to loosely insert at least one sealing means into at least one region of the recess.

The paint needle of a particularly advantageous spray gun with one-piece base body is equipped with at least one pull-back spring or actuating spring that preferably extends within the exchangeable spray medium guide unit. The spring may be braced against a stopper that is provided on the paint needle and integrally molded thereon.

The spring may be arranged between the stopper and a coupling element.

The stopper may be realized, for example, in the form of a cone or in the form of a disk and arranged inside or outside the exchangeable spray medium guide unit.

The inventive method for arranging an exchangeable spray medium guide unit in or on a spray gun with one-piece base body may include at least one rotatory motion. It may consist, for example, of a turning motion, a tilting motion or a pivoting motion. Combinations of these motion types may also be considered.

A particularly preferred method for arranging an exchangeable spray medium guide unit in or on a spray gun with one-piece base body comprises at least the following steps: the exchangeable spray medium guide unit is essentially moved into the vicinity of the recess coaxial to the axis of the recess (spray medium inlet axis) or parallel thereto such that the spray medium outlet of the exchangeable spray medium guide unit points forward. Once the spray medium outlet of the exchangeable spray medium guide unit is positioned approximately flush with the spray medium outlet of the base body, a pivoting motion is carried out in order to coaxially align the spray medium outlet of the exchangeable spray medium guide unit with the spray medium outlet of the base body.

The exchangeable spray medium guide unit may also be pivoted in the direction of the spray medium outlet of the base body such that its spray medium outlet points forward.

In an exemplary embodiment of the inventive method, the spray medium inlet of the exchangeable spray medium guide unit may during the arrangement thereof be at least temporarily inclined relative to its intended alignment.

The exchangeable spray medium guide unit may be coaxially displaced or inserted in the direction of the spray medium outlet of the base body.

The exchangeable spray medium guide unit, particularly its spray medium inlet, is preferably moved into the intended position with a slewing motion. The exchangeable spray medium guide unit may also be moved into an intended position with a different motion such as, for example, a rotation.

The method for removing the exchangeable spray medium guide unit from or out of the spray gun with one-piece base body may include at least one rotatory motion. This motion may consist, for example, of a turning motion, a tilting motion or a pivoting motion. Combinations of these motion types may also be considered. The exchangeable spray medium guide unit may be frequently subjected to an unintentional linear motion such that the exchangeable spray medium guide unit inadvertently disengages from or out of the spray gun with one-piece base body. The risk of an unintentional removal of the exchangeable spray medium guide unit from or out of the spray gun with one-piece base body is reduced due to the required rotatory component.

The method for removing an exchangeable spray medium guide unit from or out of a spray gun with one-piece base body preferably comprises at least the following steps: the exchangeable spray medium guide unit is pivoted until the spray medium outlet of the exchangeable spray medium guide unit is positioned coaxial to the spray medium inlet axis of the recess or parallel thereto. Subsequently, the exchangeable spray medium guide unit is removed from or out of the recess essentially coaxial to the spray medium inlet axis of the recess or parallel thereto.

During the removal of the exchangeable spray medium guide unit from or out of the spray gun with one-piece base body, the spray medium inlet of the exchangeable spray medium guide unit may be at least temporarily inclined relative to its intended alignment.

The exchangeable spray medium guide unit may be coaxially displaced or pushed or pulled away from the direction of the spray medium outlet of the base body. The exchangeable spray medium guide unit, particularly its spray medium inlet, is preferably moved out of the intended position by means of a slewing motion.

### BRIEF DESCRIPTION OF THE DRAWINGS

Individual exemplary embodiments of the spray gun with one-piece base body are described in greater detail below with reference to 10 drawings. In these drawings:

FIG. 1 shows a side view of the with one-piece base body base body of a first exemplary embodiment of an inventive spray gun,

FIG. 2 shows a top view of the base body of the first exemplary embodiment of an inventive spray gun with one-piece base body,

FIG. 3 shows a sectioned side view of the first exemplary embodiment of an inventive spray gun with one-piece base body including attachments and cup,

FIG. 4 shows a side view of the with one-piece base body base body of a second exemplary embodiment of an inventive spray gun,

FIG. 5 shows a top view of the with one-piece base body base body of the second exemplary embodiment of an inventive spray gun,

FIG. 6 shows a sectioned side view of the second exemplary embodiment of an inventive spray gun including attachments and cup, and

FIGS. 7 to 10 show different exchangeable spray medium guide units that are suitable for use in different embodiments of the spray gun with one-piece base body and feature different coupling elements between the paint needle and the paint needle-actuating element.

### DETAILED DESCRIPTION

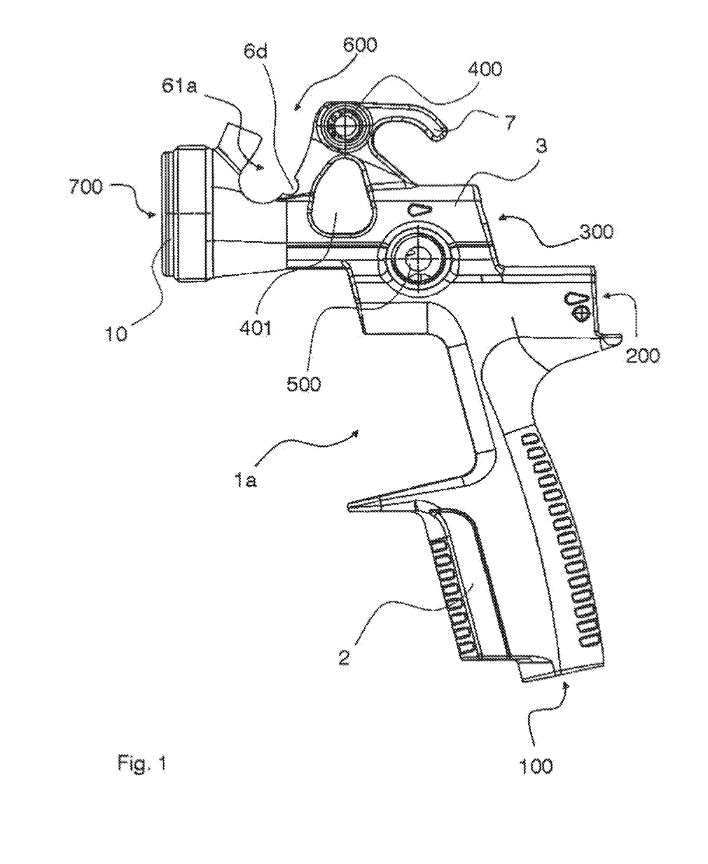

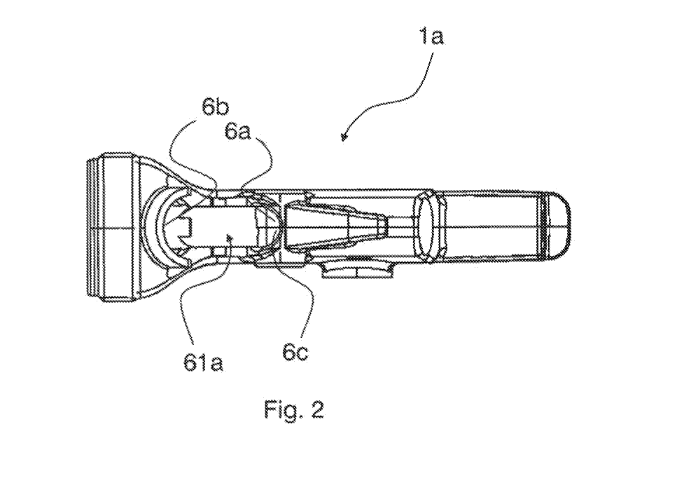

FIGS. 1 and 2 show a one-piece base body 1a of an inventive spray gun that features a handle region 2 and a head region 3. These two regions 2 and 3 conventionally extend at an angle of approximately 104 degrees to one another. The base body 1a features several openings for different attachments that are not illustrated in FIGS. 1 and 2 such as, for example, an opening 100 for a compressed air connection, an opening 200 for an air micrometer, an opening 300 for a material volume control, openings 400, 401 for a trigger and an opening 500 for a circular/broad jet control. The base body 1a furthermore features a suspension hook 7, a spray medium inlet region 600, a spray medium outlet region 700 and a thread 10 for attaching an air nozzle ring.

In the embodiment illustrated in FIGS. 1 and 2, the recess 61a is situated on the upper side of the base body 1a in the region of the spray medium inlet 600 of the base body 1a. An exchangeable spray medium guide unit can be inserted into the base body 1a of the spray gun through this recess 61a from the upper rear by means of a pivoting motion. The rear boundary of the recess 61a is formed by a concave wall section 6a of the spray medium inlet region 600 that extends in the region of the openings 400, 401 for a trigger 40 that is not illustrated in these figures. On the other hand, the front boundary of the recess 61a is formed by a concave wall section 6b of the spray medium inlet region 600 that extends in the region of the beginning of the thread 10 for attaching an air nozzle ring. The bottom boundary of the recess 61a is formed by the bottom section 6c of the spray gun base body 1a. The recess 61a may also feature lateral boundaries that are formed by wall sections of the spray gun base body 1a. Alternatively, a lateral boundary can be at least partially eliminated. In contrast to a conventional spray medium inlet region, a U-shaped area is cut out of the spray medium inlet region in the embodiment illustrated in FIG. 1. The recess 61a is in comparison with a conventional spray medium inlet region widened toward the front in the direction of the spray medium outlet and/or toward the rear in order to allow the insertion and removal of the exchangeable spray medium guide unit. In the region of the recess 61a, the base body 1a features a groove 6d that serves for fixing the exchangeable spray medium guide unit.

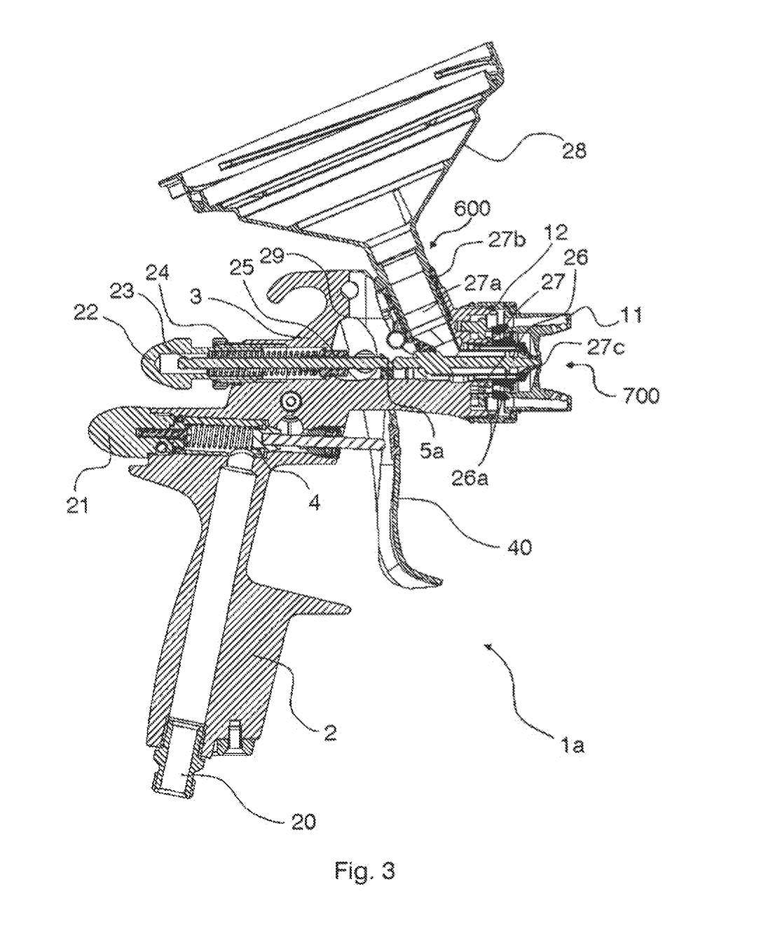

FIG. 3 shows a sectioned side view of the first embodiment of the inventive spray gun with one-piece base body including attachments.

The base body 1a features a compressed air connection 20 on its lower end. Several air conduits that are not illustrated in their entirety extend from the compressed air connection 20 through the handle region 2 and through the head 3 and end at the spray medium outlet region 700 of the spray gun head 3. The volume and the pressure of the air flowing through these air conduits can be conventionally adjusted by means of an air micrometer 21. The spray medium outlet region 700 of the head 3 is equipped with an air nozzle 11 that features protruding horns with openings. The spray gun is furthermore equipped with an air nozzle ring 12.

An exchangeable spray medium guide unit 27 is inserted into the recess 61a and extends beyond the recess 61a in the region of the spray medium inlet 600 and in the region of the spray medium outlet 700 of the base body 1a. The outlet region 27c of the exchangeable spray medium guide unit 27 essentially extends up to the outer end of the outlet of the air nozzle 11. The exchangeable spray medium guide unit 27 is pressed against the front wall section 6b with the aid of a fixing means 29 and thusly locked in position. In the exemplary embodiment shown, essentially the entire upper front region of the recess serves as contact region for the exchangeable spray medium guide unit 27. In this way, a firm seat of the exchangeable spray medium guide unit 27 in the base body 1a is ensured.

The paint needle 26 is arranged within the exchangeable spray medium guide unit 27 and guided therein by means of webs 26a. When the trigger 40 is not actuated, the outlet region 27c of the exchangeable spray medium guide unit 27 is closed by the paint needle 26.

In the present exemplary embodiment, the spray medium guide unit 27 features a thread 27a for screwing in or screwing on a material supply device 28, namely a gravity-feed cup 28 that is only schematically indicated in FIG. 3. After the gravity-feed cup 28 filled with a spray medium has been screwed in or screwed on the exchangeable spray medium guide unit 27, the spray medium flows from the gravity-feed cup 28 into the inlet region 27b of the exchangeable spray medium guide unit 27, in which it remains as long as the outlet region 27c of the exchangeable spray medium guide unit 27, which in this case is realized in the form of a nozzle, is closed by the paint needle 26.

The air valve 4 is opened when the trigger 40 is actuated up to a first pressure point. This causes compressed air to be conveyed to the air nozzle 11 through the compressed air conduits. When the trigger 40 is additionally pulled back, the paint needle-actuating element 23 is moved and retracts the paint needle 26 from the outlet region 27c of the exchangeable spray medium guide unit 27 by means of a coupling element 5a. At this point, the spray medium can exit the exchangeable spray medium guide unit 27 and be atomized by the compressed air being discharged from the air nozzle 11.

A spring 24 with a stopper 25 is regionally arranged around the paint needle-actuating element 23 and presses the paint needle 26 into the outlet of the air nozzle 11 when the trigger 40 is not actuated in order to close the outlet.

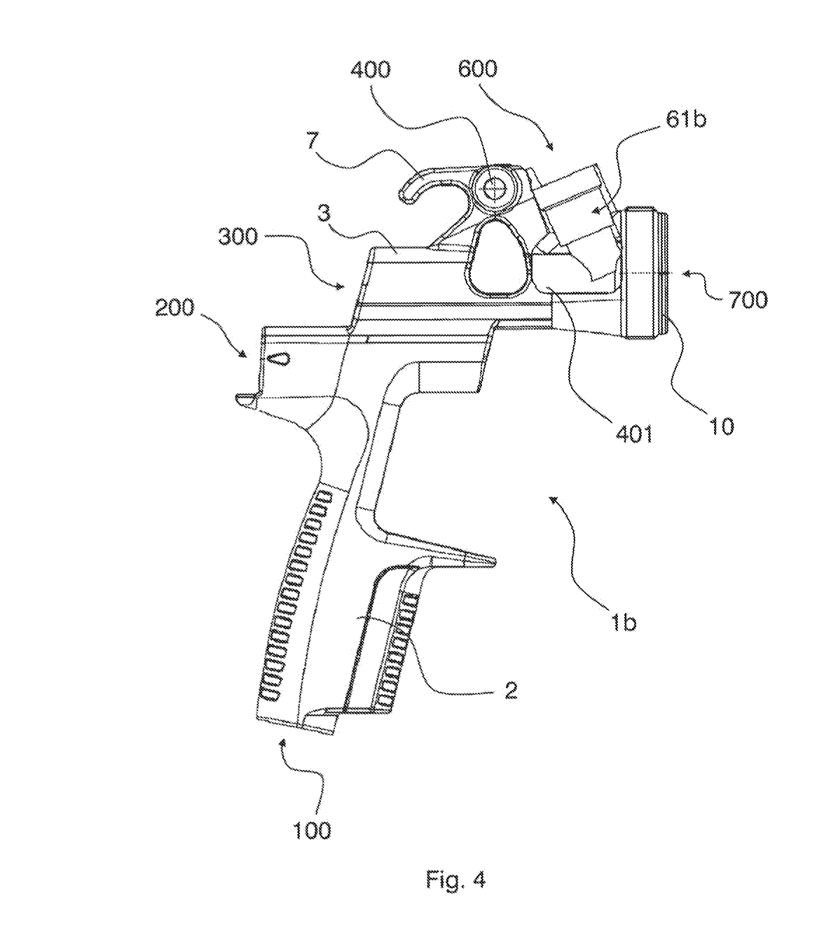

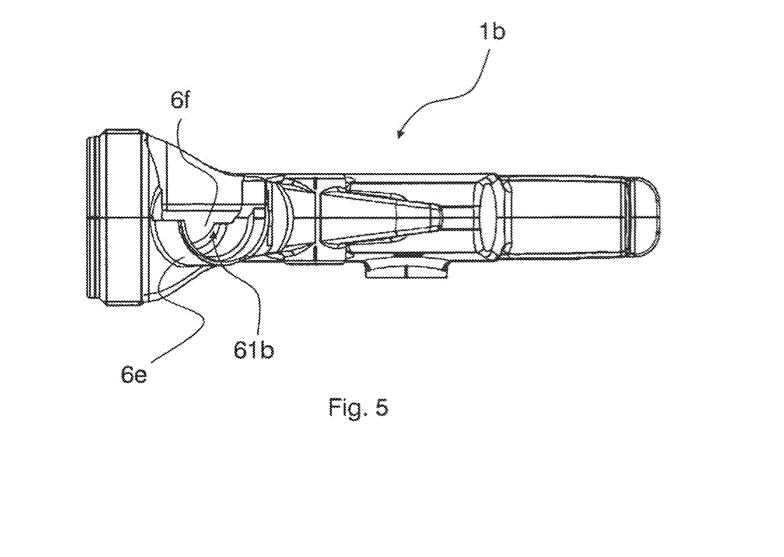

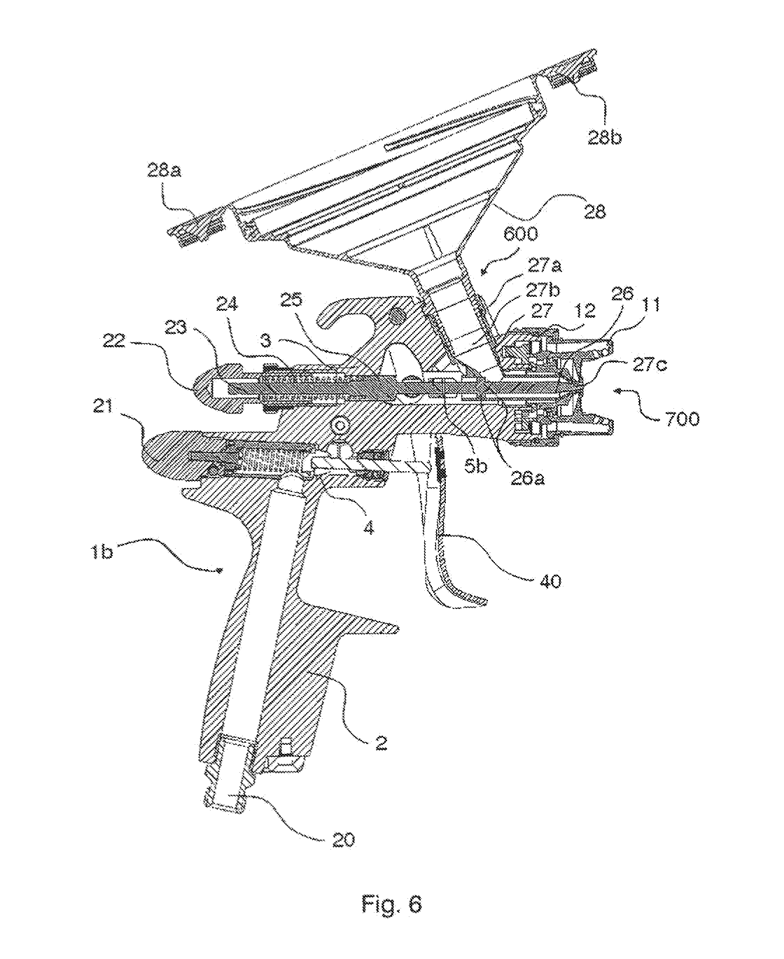

FIGS. 4 to 6 show another embodiment of an inventive spray gun with one-piece base body. FIGS. 4 and 5 respectively show only the base body 1b while FIG. 6 shows the spray gun including attachments and cup.

The base body of the second exemplary embodiment features a handle region 2 and a head 3 and is realized similar to the base body of the first exemplary embodiment. The base body 1b features openings for not-shown attachments such as, among other things, an opening 100 for a compressed air connection 20, an opening 200 for an air micrometer 21, an opening 300 for a material volume control 22, openings 400, 401 for a trigger 40 and an opening 500 for a circular/broad jet control that is not visible in FIG. 4. The base body 1b furthermore features a suspension hook 7, a spray medium inlet region 600, a spray medium outlet region 700 and a thread 10 for attaching an air nozzle ring.

In the present exemplary embodiment, the base body 1b features a recess 61b with an inlet region 600 and an outlet region 700 that is suitable for accommodating an exchangeable spray medium guide unit. In the embodiment illustrated in FIGS. 4 to 6, the recess 61b is essentially arranged laterally on the base body 1b and extends up to the upper side of the base body 1b. In comparison with a conventional spray gun, a lateral region of the head 3 is partially removed. The boundaries of the recess are formed by a lateral section 6e and a bottom section 6f. In the embodiment illustrated in FIG. 5, the partially opened concave lateral section 6e has an aperture angle of approximately 180°. However, the aperture angle is preferably smaller and lies, in particular, between 100° and 179°. In this way, the recess is suitable for accommodating a cylindrical exchangeable spray medium guide unit. An aperture angle of less than 180° makes it possible to positively arrange the exchangeable spray medium guide unit in the recess.

FIG. 6 shows a sectioned side view of the second embodiment of the inventive spray gun with one-piece base body including attachments.

Similar to the first exemplary embodiment, the base body 1b in this embodiment features a compressed air connection 20 on its lower end. Several air conduits that are not illustrated in their entirety also extend from the compressed air connection 20 through the handle region 2 and the head 3 and end at the spray medium outlet region 700 of the spray gun head 3 in this case. In addition, this exemplary embodiment also features an air micrometer 21, an air nozzle 11 with protruding horns that contain openings and an air nozzle ring 12.

An exchangeable spray medium guide unit 27 is inserted into the recess 61b and extends beyond the recess 61b in the region of the spray medium inlet 600 and in the region of the spray medium outlet 700 of the base body 1b. The outlet region 27c of the exchangeable spray medium guide unit 27 essentially extends up to the outer end of the outlet of the air nozzle 11. The exchangeable spray medium guide unit 27 is held by a not-shown fixing means. This fixing means preferably consists of an integral hinge, one end of which is permanently connected to the exchangeable spray medium guide unit 27, preferably injection-molded thereon, and the other end of which can be separably connected to the base body 1b, preferably by means of a plug connection or clip connection. In the exemplary embodiment shown, essentially one entire lateral half of the recess serves as the contact region for the exchangeable spray medium guide unit 27. In this way, a firm seat of the exchangeable spray medium guide unit 27 in the base body 1b is ensured.

The paint needle 26 is arranged within the exchangeable spray medium guide unit 27 and guided therein by means of webs 26a as in the first exemplary embodiment. When the trigger 40 is not actuated, the outlet region 27c of the exchangeable spray medium guide unit 27 is closed by the paint needle 26.

As in the first exemplary embodiment, the spray medium guide unit 27 in the present exemplary embodiment also features a thread 27a for screwing in or screwing on a material supply device 28, namely a gravity-feed cup 28 that is only schematically indicated in FIG. 6. After the gravity-feed cup 28 filled with a spray medium has been screwed in or screwed on the exchangeable spray medium guide unit 27, the spray medium flows from the gravity-feed cup 28 into the inlet region 27b of the exchangeable spray medium guide unit 27, in which it remains as long as the outlet region 27c of the exchangeable spray medium guide unit 27, which in this case is realized in the form of a nozzle, is closed by the paint needle 26.

The air valve 4 is opened when the trigger 40 is actuated up to a first pressure point. This causes compressed air to be conveyed to the air nozzle 11 through the compressed air conduits. When the trigger 40 is additionally pulled back, the paint needle-actuating element 23 is moved and retracts the paint needle 26 from the outlet region 27c of the exchangeable spray medium guide unit 27 by means of a coupling element 5b. At this point, the spray medium can exit the exchangeable spray medium guide unit 27 and be atomized by the compressed air being discharged from the air nozzle 11.

A spring 24 with a stopper 25 is regionally arranged around the paint needle-actuating element 23 and presses the paint needle 26 into the outlet of the air nozzle 11 when the trigger 40 is not actuated in order to close the outlet.

Sealing elements 28a and 28b are arranged on the cup 28 schematically indicated in FIG. 6 by means of predetermined breaking points. If the cup is not completely empty after its use, such an element can be broken off the cup and placed on the outlet region thereof in order to seal this outlet region. In this way, the spray medium situated in the cup can be preserved for subsequent use.

The sealing elements 28a and 28b can be eliminated if the exchangeable spray medium guide unit 27 can be sealed by the paint needle 26, wherein the paint needle 26 may be held in the outlet region 27c of the exchangeable spray medium guide unit 27, for example, by means of friction.

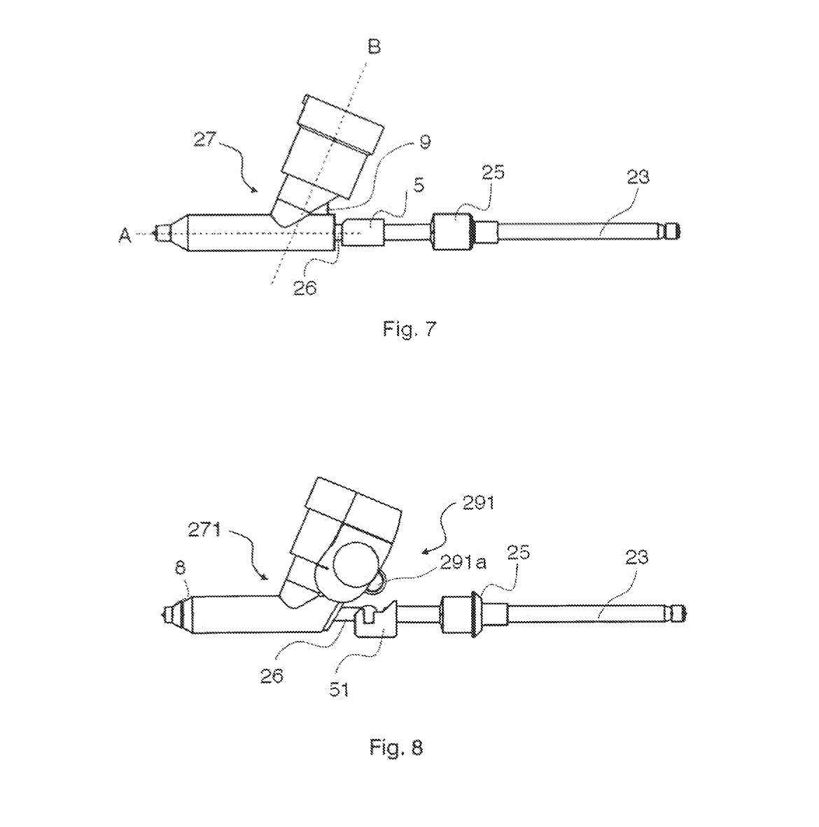

FIG. 7 shows a simple example of an exchangeable spray medium guide unit 27 without details regarding the fixing means and the coupling element. It essentially has a biaxial design and consists at least of several assembled cylinders, cylinder sections and cones. A component of the exchangeable spray medium guide unit 27 that extends along an axis A is penetrated by the paint needle 26. This component essentially consists of an elongated cylinder, an additional cylinder that has a smaller diameter and a smaller length than the nozzle and may also be realized in the form of a cone and a cone that is arranged between the two cylinders and forms the transition between the two cylinders. Two additional cylinders are arranged along an axis B that preferably intersects the axis A at an angle of approximately 110° and have diameters that are similar to one another, but larger than the diameters of the cylinders on the axis A. The larger of the two cylinders preferably features a thread for screwing in a cup. The thinner cylinder corresponds to a threadless connection of the cup and serves for the additional guidance thereof. It would naturally also be possible to utilize all other types of connections. The cylinders arranged along the axes A and B are connected by means of at least one asymmetric cone in such a way that a spray medium can flow from a cup into the cylinders arranged along the axis A through the cylinders arranged along the axis B with the least interference possible. In order to mechanically support the transition region between the axes A and B, a support element 9 in the form of a small triangular plate is arranged in the small angle between the axes.

The paint needle 26 is preferably connected to the paint needle-actuating element 23 in a separable fashion by means of a coupling element 5. The paint needle-actuating element 23 features a stopper 25, wherein a spring 24 that is not illustrated in FIGS. 7 to 10 is braced against said stopper.

The exchangeable spray medium guide unit 27 may naturally also consist of a greater or smaller number of cylinders and cones and of different shapes and combinations that may transform into one another, for example, in a stepped or smooth fashion. The mechanical support may also be realized differently and be arranged on a different side.

Such a simple exchangeable spray medium guide unit 27 can be fixed in the base body, for example, by means of an integral hinge. One end of this integral hinge is permanently connected to the exchangeable spray medium guide unit 27, preferably injection-molded thereon, and its other end can be separably connected to the base body 1b, preferably by means of a plug connection or clip connection.

FIGS. 8 to 10 show enhancements of the embodiment illustrated in FIG. 7 that are based on this basic shape of an exchangeable spray medium guide unit.

The exemplary embodiments illustrated in FIGS. 8 to 10 feature an attached nozzle 8 that can be arranged on the exchangeable spray medium guide unit. For example, the nozzle 8 may be attached to or inserted into the original nozzle, bonded thereto or arranged thereon otherwise, but it may also be attached to or arranged on an exchangeable spray medium guide unit that originally did not feature a nozzle.

In the arrangement illustrated in FIG. 8, the coupling element between the paint needle 26 and the paint needle-actuating element 23 is realized in the form of a ball coupling 51. One of the two elements to be coupled features a ball that can be inserted into a corresponding counterelement in such a way that the two elements are positively connected in at least one direction. The counterelement is opened in that at least one other direction in order to allow a simple disengagement of the coupling. The fixing element 291 of the exchangeable spray medium guide unit features a counterelement 291a for engaging into the groove 6d illustrated in FIG. 1. When the exchangeable spray medium guide unit 271 is inserted into the recess 61a of the base body 1a of a spray gun, this counterelement 291a snaps into the groove 6d and positively fixes the exchangeable spray medium guide unit 271 in the base body 1a. For the removal, flexible regions of the fixing element are compressed such that the counterelements 291a are inwardly pressed out of the groove 6d and release the exchangeable spray medium guide unit 271. The exchangeable spray medium guide unit can then be pulled out of the recess 61a. The counterelement 291a and the groove 6d may naturally also be realized differently such as, for example, in the form of a hook and eyelet and arranged at different locations of the recess 61a and the exchangeable spray medium guide unit 271. The base body 1b illustrated in FIGS. 1 to 3 may also feature a groove for accommodating the exchangeable spray medium guide unit 271.

The coupling element in FIG. 9 consists of a bolt coupling 52. Two bolts laterally protrude from one element to be coupled and can engage into a corresponding receptacle on the other elements to be coupled. The fixing means 292 of the exchangeable spray medium guide unit 272 features a catch mechanism 292a. This catch mechanism consists of an elastic region, the outer edge of which is under the influence of a force situated flush with the outer edge of the exchangeable spray medium guide unit 272. A step 292b is formed when the elastic region is not actuated. The elastic region is pressed inward when the exchangeable spray medium guide unit 272 is inserted into the recess. The recess is realized in such a way that the elastic region springs back into its original position after the complete insertion and a step of the base body abuts on the step 292b in order to thusly fix the exchangeable spray medium guide unit 272. The elastic region is provided with two tabs that can be pressed inward in order to remove the exchangeable spray medium guide unit 272 from the recess. Other catch mechanisms and removal mechanisms may also be considered.

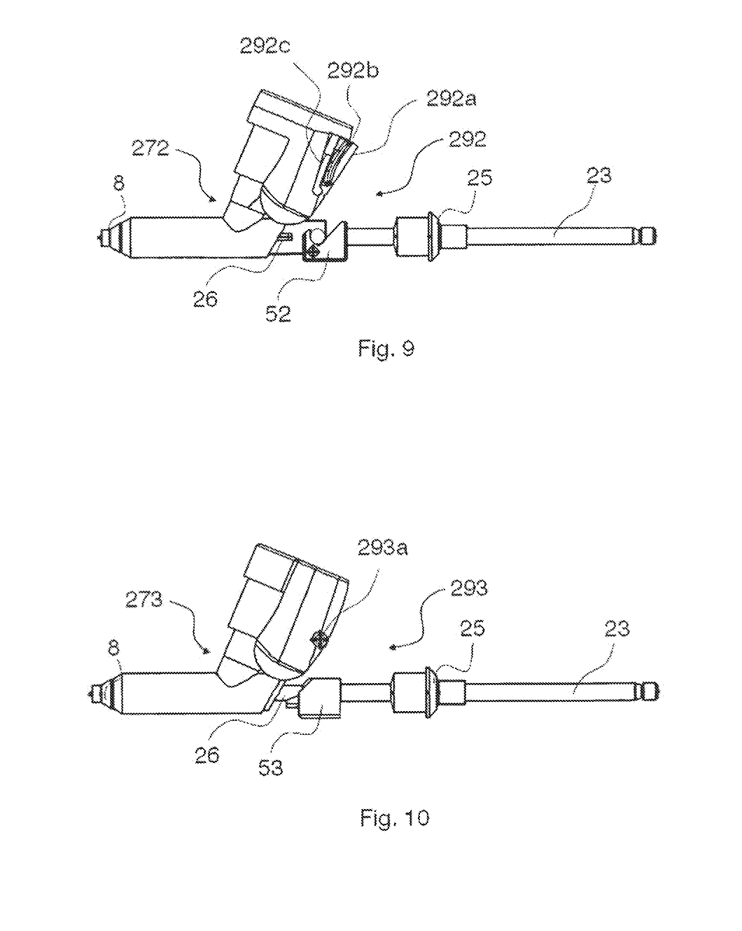

Another option for coupling the paint needle 26 to the paint needle-actuating element 23 is schematically illustrated in FIG. 10. In this case, the connection is realized in the form of a prism coupling 53. The first half of the coupling element consists of a prism that can be inserted into a corresponding counterelement from above. The exchangeable spray medium guide unit 273 features a fixing means 293 with an eccentric element 293a. The eccentric element 293a can be turned by means of a lever that is not visible in FIG. 10. During the insertion of the exchangeable spray medium guide unit 273 into the recess, the lever is situated in a position in which the narrow side of the eccentric element 293a points outward. After the insertion, the lever is turned such that the broad side of the eccentric element 293a points upward and clamps the exchangeable spray medium guide unit 273 in the recess.

The fixing element may naturally also be realized differently such as, for example, with a slide that tensions the exchangeable spray medium guide unit when it is inserted into slots on the fixing element. Combinations of different fixing elements may also be considered.

Essentially identical components, particularly the paint needle-actuating element 23 and the stopper 25, are identified by the same reference symbols in FIGS. 7 to 10.

In conclusion, it should be noted that the described exemplary embodiments merely represent a limited selection of potential embodiments and therefore do not restrict the present invention in any way.

1-121. (canceled)

122. A spray gun with a one-piece base body, a trigger, a paint needle-actuating element that is coupled to the trigger, a paint needle that is coupled to the paint needle-actuating element and an exchangeable spray medium guide unit, the inlet region of which is connected or can be connected to a material supply device for the material to be sprayed, wherein the base body features at least one recess for accommodating the exchangeable spray medium guide unit.

123. The spray gun according to claim 122, wherein the recess is situated on the upper side or on the underside of the base body or laterally on the base body.

124. The spray gun according to claim 123, wherein the recess extends from a spray medium inlet to a spray medium outlet of the base body.

125. The spray gun according to claim 124, wherein the recess features at least one concave region.

126. The spray gun according to claim 125, wherein the at least one concave region is at least partially opened on its side that faces away from the spray medium outlet, at least partially opened on its side that faces the spray medium outlet, at least partially opened toward the bottom, at least partially opened toward the top or at least partially opened laterally.

127. The spray gun according to claim 126, wherein the at least one concave region at least partially has an aperture angle of less than 180°, preferably between 100° and 179°.

128. The spray gun according to claim 127, wherein the recess is realized in such a way that the exchangeable spray medium guide unit can be pivoted or pushed into the recess or arranged by means of several superimposed or successive motions.

129. The spray gun according to claim 128, wherein the recess is realized in such a way that the exchangeable spray medium guide unit can be arranged in or on the recess by means of a positive fit, a taper or a restraint

130. The spray gun according to claim 129, wherein the exchangeable spray medium guide unit can be radially or axially fixed in or on the recess by means of at least one contact region or of at least one element.

131. The spray gun according to claim 130, wherein the at least one element features a shoulder, a ring, a cone, a web, a hook and/or an eyelet.

132. The spray gun according to claim 131, wherein at least one element is arranged on the exchangeable spray medium guide unit or on the base body.

133. The spray gun according to claim 132, wherein at least one element is arranged on the exchangeable spray medium guide unit and a counterelement is arranged on the base body.

134. The spray gun according to claim 127, wherein the base body features one or more compressed air conduits which extend in at least one part of the base body that does not contain a recess.

135. The spray gun according to claim 134, wherein the exchangeable spray medium guide unit can be locked on or in the base body with the aid of at least one fixing means.

136. The spray gun according to claim 135, wherein the at least one fixing means features at least one mechanical element, a nonpositive or positive connection, an integral hinge, a catch mechanism, an eccentric element or a screw mechanism.

137. The spray gun according to claim 136, wherein the exchangeable spray medium guide unit consists of several components.

138. The spray gun according to claim 137, wherein a nozzle is arranged or can be arranged on the exchangeable spray medium guide unit in a separable or inseparable fashion.

139. The spray gun according to claim 137, wherein the exchangeable spray medium guide unit consists at least of a first component that can be placed into the base body or arranged thereon in the region of the spray medium outlet, and a second component that can be placed into the base body or arranged thereon in the region of the spray medium inlet.

140. The spray gun according to claim 137, wherein at least one sealing means is arranged or can be arranged in the connecting region of the components of the exchangeable spray medium guide unit.

141. The spray gun according to claim 137, wherein the exchangeable spray medium guide unit extends beyond the recess in the region of the spray medium outlet or in the region of the spray medium inlet of the base body.

142. The spray gun according to claim 137, wherein the exchangeable spray medium guide unit ends before the recess or flush therewith in the region of the spray medium outlet or in the region of the spray medium inlet of the base body.

143. An exchangeable spray medium guide unit, wherein the exchangeable spray medium guide unit is arrangeable in or on a spray gun according to claim 122.

144. A material supply device, wherein the material supply device is attachable to a spray gun according to claim 122 and/or to an exchangeable spray medium guide unit arrangeable in or on the spray gun.

145. A cover, wherein the cover is attachable to a spray gun according to claim 122 and/or to an exchangeable spray medium guide unit arrangeable in or on the spray gun.

146. A method for arranging an exchangeable spray medium guide unit in or on a spray gun with one-piece base body, wherein the exchangeable spray medium guide unit is arranged in or on a recess of a base body of the spray gun.

147. The method according to claim 146, wherein the arrangement of the exchangeable spray medium guide unit in or on the recess includes at least one rotatory motion and in that the rotatory motion is a turning, tilting or pivoting motion.

148. The method according to claim 147, further comprising:
moving the exchangeable spray medium guide unit into the vicinity of the recess essentially coaxial to the axis of the spray medium inlet axis of the recess or parallel thereto such that the spray medium outlet of the exchangeable spray medium guide unit points forward until the spray medium outlet of the exchangeable spray medium guide unit is positioned approximately flush with the spray medium outlet of the base body,
pivoting the exchangeable spray medium guide unit until the spray medium outlet of the exchangeable spray medium guide unit is positioned coaxial to the spray medium outlet of the base body.

149. A method for removing an exchangeable spray medium guide unit from or out of a spray gun with one-piece base body, wherein the exchangeable spray medium guide unit is removed from or out of a recess of a base body of the spray gun.

150. The method according to claim 149, wherein the removal of the exchangeable spray medium guide unit from or out of the recess includes at least one rotatory motion and in that the rotatory motion is a turning, tilting or pivoting motion.

151. The method according to claim 150, comprising:
pivoting the exchangeable spray medium guide unit until the spray medium outlet of the exchangeable spray medium guide unit is positioned coaxial to the spray medium inlet axis of the recess or parallel thereto,
removing the exchangeable spray medium guide unit from or out of the recess essentially coaxial to the spray medium inlet axis of the recess or parallel thereto.
